(19) United States
(12) Patent Application Publication
(10) Pub. No.: US 2015/0037490 A1
(43) Pub. Date: Feb. 5, 2015

(54) FROZEN DESSERT MIXES USING CANOLA PROTEIN PRODUCTS

(71) Applicants: Martin Schweizer, Winnipeg (CA); Kevin I. Segall, Winnipeg (CA); Sarah Medina, Winnipeg (CA)

(72) Inventors: Martin Schweizer, Winnipeg (CA); Kevin I. Segall, Winnipeg (CA); Sarah Medina, Winnipeg (CA)

(21) Appl. No.: 14/378,196

(22) PCT Filed: Feb. 14, 2013
(86) PCT No.: PCT/CA2013/000122

§ 371 Date: Aug. 12, 2014

Related U.S. Application Data
(60) Provisional application No. 61/599,048, filed on Feb. 15, 2012.
(60) Provisional application No. 61/739,037, filed on Dec. 19, 2012.

(51) Int. Cl. A23G 9/32

(52) U.S. Cl. CPC A23G 9/32
USPC 426/654

(57) ABSTRACT

A canola protein product having a protein content of at least about 60 wt % (N×6.25) d.b., preferably at least about 90 wt %, and consisting predominantly of 2S canola protein and derived from supernatant from a protein micellar mass settling step is used to provide, at least in part, the protein component of a dairy analogue or plant/dairy blend frozen dessert mix.

### REFERENCE TO RELATED APPLICATIONS

This application claims priority pursuant to 35 USC 119(e) from U.S. Provisional Patent Application No. 61/599,048 filed Feb. 15, 2012 and 61/739,037 filed Dec. 19, 2012.

### FIELD OF INVENTION

The invention relates to mixes used in the preparation of dairy analogue frozen dessert products and frozen dessert products that are plant/dairy blends, prepared using a canola protein product, particularly an isolate.

### BACKGROUND TO THE INVENTION

Canola oil seed protein isolates having protein contents of at least 100 wt % (N×6.25) can be formed from oil seed meal by a process as described in copending U.S. patent application Ser. No. 10/137,391 filed May 3, 2002 (U.S. Patent Application Publication No. 2003-0125526 A1 and WO 02/089597) and U.S. patent application Ser. No. 10/476,230 filed Jun. 9, 2004 (U.S. Patent Application Publication No. 2004-0254353 A1), (now U.S. Pat. No. 7,687,087), assigned to the assignee hereof and the disclosures of which are incorporated herein by reference. The procedure involves a multiple step process comprising extracting canola oil seed meal using an aqueous salt solution, separating the resulting aqueous protein solution from residual oil seed meal, increasing the protein concentration of the aqueous solution to at least about 200 g/L while maintaining the ionic strength substantially constant by using a selective membrane technique, diluting the resulting concentrated protein solution into chilled water to cause the formation of protein micelles, settling the protein micelles to form an amorphous, sticky, gelatinous, gluten-like protein micellar mass (PMM), and recovering the protein micellar mass from supernatant, the PMM having a protein content of at least about 100 wt % (N×6.25). As used herein, protein content is determined on a dry weight basis. The recovered PMM may be dried.

In one embodiment of the process, the supernatant from the PMM settling step is processed to recover canola protein isolate from the supernatant. This procedure may be effected by initially concentrating the supernatant using an ultrafiltration membrane and drying the concentrate. The resulting canola protein isolate has a protein content of at least about 90 wt %, preferably at least about 100 wt % (N×6.25).

The procedures described in U.S. patent application Ser. Nos. 10/137,391 and 13/476,230 are essentially batch procedures. In U.S. patent application Ser. No. 10/298,678 filed Nov. 19, 2002 (U.S. Patent Application Publication No. 2004-0039174 A1 and WO 03/043439) (now abandoned), U.S. patent application Ser. No. 12/230,199 filed Aug. 26, 2008 (now U.S. Pat. No. 7,704,534), U.S. patent application Ser. No. 10/496,071 filed Mar. 5, 2005 (U.S. Patent Application Publication No. 2003-0015910 A1) (now abandoned) and U.S. patent application Ser. No. 12/230,303 filed Aug. 27, 2008 (now U.S. Pat. No. 7,625,588), assigned to the assignee hereof and the disclosures of which are incorporated herein by reference, there is described a continuous process for making canola protein isolates. In accordance therewith, canola oil seed meal is continuously mixed with an aqueous salt solution, the mixture is conveyed through a pipe while extracting protein from the canola oil seed meal to form an aqueous protein solution, the aqueous protein solution is continuously conveyed through a selective membrane operation to increase the protein content of the aqueous protein solution to at least about 50 g/L, while maintaining the ionic strength substantially constant, the resulting concentrated protein solution is continuously mixed with chilled water to cause the formation of protein micelles, and the protein micelles are continuously permitted to settle while the supernatant is continuously overflowed until the desired amount of PMM has accumulated in the settling vessel. The PMM is recovered from the settling vessel and may be dried. The PMM has a protein content of at least about 90 wt % (N×6.25), preferably at least about 100 wt %. The overflowed supernatant may be processed to recover canola protein isolate therefrom, as described above.

Canola seed is known to contain about 10 to about 30 wt % proteins and several different protein components have been identified. These proteins include a 12S globulin, known as cruciferin, a 7S protein and a 2S storage protein, known as napin. As described in copending U.S. patent application Ser. No. 10/413,371 filed Apr. 15, 2003 (U.S. Patent Application Publication No. 2004-0034200 A1 and WO 03/088760) (now U.S. Pat. No. 7,662,922), U.S. patent application Ser. No. 10/510,766 filed Apr. 29, 2005 (U.S. Patent Application Publication No. 2005-0249828 A1) (now abandoned) and U.S. patent application Ser. No. 12/618,432 filed Nov. 13, 2009 (US Patent Publication No. 2010-0063255 published Mar. 11, 2010) (now abandoned), assigned to the assignee hereof and the disclosures of which are incorporated herein by reference, the procedures described above, involving dilution of concentrated aqueous protein solution to form PMM and processing of supernatant to recover additional protein, lead to the recovery of isolates of different protein profiles.

In this regard, the PMM-derived canola protein isolate has a protein component composition of about 60 to about 98 wt % of 7S protein, about 1 to about 15 wt % of 12S protein and 0 to about 25 wt % of 2S protein. The supernatant-derived canola protein isolate has a protein component composition of about 60 to about 95 wt % of 2S protein, about 5 to about 40 wt % of 7S protein and 0 to about 5 wt % of 12S protein. Thus, the PMM-derived canola protein isolate is predominantly 7S protein and the supernatant-derived canola protein isolate is predominantly 2S protein. As described in the aforementioned U.S. patent application Ser. No. 10/413,371, the 2S protein has a molecular mass of about 14,000 Daltons, the 7S protein has a molecular mass of about 145,000 Daltons and the 12S protein has a molecular mass of about 290,000 Daltons.

In U.S. Pat. No. 7,959,968 issued Jun. 14, 2011 and U.S. Pat. No. 7,981,450 issued Jul. 19, 2011, assigned to the assignee hereof and the disclosures of which are incorporated herein by reference, there is described a novel canola protein isolate consisting predominantly of 2S canola protein and having improved solubility properties and a greater proportion of 2S canola protein and a lesser proportion of 7S canola protein than supernatant from canola protein micelle formation and precipitation. The process involves heating the supernatant from PMM formation, optionally after concentration, to precipitate 7S protein and, following removal of the precipitated 7S protein, drying the heat-treated solution.

In U.S. Pat. No. 8,142,822 issued Mar. 27, 2012 and U.S. patent application Ser. No. 12/737,085 filed Apr. 15, 2011 (US Patent Publication No. 2011/0200720 published Aug. 18, 2011), assigned to the assignee herein and the disclosure of which are incorporated herein by reference, there is described another procedure for the preparation of a canola protein isolate consisting predominantly of 2S canola protein and a lesser proportion of 7S canola protein than the supernatant from canola protein micelle formation and precipitation. The process involves isoelectrically precipitating 7S canola protein from the supernatant, optionally after concentration, followed by drying after removal of the precipitated 7S canola protein.

In U.S. patent application Ser. No. 12/542,922 filed Aug. 18, 2009 (US Patent Publication No. 2010/0040763 published Feb. 18, 2010) (“C200Ca”) (now U.S. Pat. No. 8,343,566 issued Jan. 1, 2013) and Ser. No. 12/662,594 filed Apr. 21, 2010 (US Patent Publication No. 2010/0291285 published Nov. 10, 2010) (“C200CaC”) assigned to the assignee hereof and the disclosures of which are incorporated herein by reference, there is described another procedure for the preparation of canola protein product consisting predominantly of 2S canola protein which does not involve such heat treatment and yet produces a product which is not only completely soluble, transparent and heat-stable in water at low pH but also is generally lower in phytic acid.

The procedure described in the latter US patent applications involves:
adding a calcium salt, preferably calcium chloride, to supernatant from the precipitation of a canola protein micellar mass to provide a conductivity of about 5 mS to about 30 mS, preferably about 8 to about 10 mS, to form calcium phytate precipitate,
removing precipitated calcium phytate from the resulting solution to provide a clear solution,
optionally adjusting the pH of the clear solution to about 2.0 to about 4.0, preferably about 2.9 to about 3.2, such as by the addition of hydrochloric acid,
concentrating the optionally pH-adjusted clear solution to a protein content of at least about 50 g/L, preferably about 50 to about 500 g/L, more preferably about 100 to about 250 g/L, to produce a clear concentrated canola protein solution,
optionally diafiltering the clear concentrated canola protein solution, such as with volumes of pH 3 water,
optionally effecting a colour removal step, such as a granular activated carbon treatment, and
drying the concentrated protein solution to produce a canola protein product.

While the canola protein product preferably is a canola protein isolate having a protein content of at least about 90 wt % (N×6.25) d.b., more preferably at least about 100 wt % (N×6.25) d.b., as described in the aforementioned U.S. patent application Ser. No. 12/542,922, the canola protein product may have a lesser purity, from about 60 wt % (N×6.25 d.b.) to less than 90 wt % (N×6.25) d.b., as described in the aforementioned U.S. patent application Ser. No. 12/662,594.

The supernatant may be partially concentrated to an intermediate concentration prior to addition of the calcium salt. The precipitate which forms is removed and the resulting solution is optionally acidified as described above, further concentrated to the final concentration and then optionally diafiltered and dried.

Alternatively, the supernatant first may be concentrated to the final concentration, the calcium salt is added to the concentrated supernatant, the resulting precipitate is removed and the solution is optionally acidified and then optionally diafiltered and dried.

It is an option in the above-described procedures to omit the removal of the precipitate, which leads to a higher phytate content in the product. In such procedure, the calcium salt is added to the supernatant, partially concentrated supernatant or fully concentrated supernatant and the precipitate is not removed. Acidification leads to resolubilization of the precipitate.

A further option is to omit the acidification and effect processing of the solution at natural pH. In this option calcium salt is added to supernatant, partially concentrated supernatant or concentrated supernatant to form a precipitate which is removed. The resulting solution then is processed as described above without the acidification step.

Where the supernatant is partially concentrated prior to the addition of the calcium salt and fully concentrated after removal of the precipitate, the supernatant is first concentrated to a protein concentration of about 50 g/L or less, and, after removal of the precipitate, then is concentrated to a protein concentration of at least about 50 g/L, preferably about 50 to about 500 g/L, more preferably about 100 to about 250 g/L.

In another variation of the above described process, the calcium salt may be added in two stages with a small amount of calcium initially added to the supernatant to provide a conductivity of about 1 mS to about 3.5 mS, preferably about 1 mS to about 2 mS, which is insufficient to cause the formation of a precipitate.

The resulting solution is acidified and partially concentrated under the conditions described above. The balance of the calcium salt is added to the partially concentrated solution to provide a conductivity of about 4 mS to about 30 mS, preferably about 4 to about 10 mS, to result in the formation of a precipitate. The precipitate then is removed. The resulting clear solution is concentrated to its final concentration under the conditions described above and then may be diafiltered and dried.

### SUMMARY OF THE INVENTION

It has now been found that these novel canola protein products having a protein content of at least about 60 wt % (N×6.25) d.b., preferably at least about 90 wt %, more preferably at least about 100 wt %, comprised predominantly of 2S protein and derived from the supernatant from a PMM settling step, may be effectively used in dairy analogue frozen dessert mixes or mixes that are blends of dairy and plant ingredients, as an at least partial substitute for conventional proteinaceous ingredients derived from milk, soy or other sources. Such frozen dessert mixes, which have good flavour properties, may then be frozen in the preparation of frozen dessert products, which also have good flavour properties. Such frozen dessert products include but are not limited to scoopable frozen desserts, soft serve frozen desserts and frozen novelty products such as molded or extruded products that may or may not be provided on sticks. Such frozen dessert products may contain any manner of inclusion, such as syrups, fruits, nuts and/or other particulates, or coatings in the case of the frozen novelty products, in combination with the frozen, frozen dessert mix.

In very general terms, frozen dairy dessert mixes, dairy analogue frozen dessert mixes and frozen dessert mixes that are plant/dairy blends all typically comprise water, protein, fat, flavourings, sweetener and other solids along with stabilizers and emulsifiers. The proportions of these components vary depending on the desired composition of the frozen dessert product. The range of dairy analogue or plant/dairy blend frozen dessert products that may be prepared from dairy analogue or plant/dairy blend frozen dessert mixes may be considered to be equivalent to the range of frozen dairy dessert products that may be prepared from frozen dairy dessert mixes.

Suggested mix compositions for a variety of frozen dairy desserts can be found at http://www.uoguelph.ca/foodscience/dairy-science-and-technology/dairy-products/ice-cream/ice-cream-formulations/suggested-mixes (Professor H. Douglas Goff, Dairy Science and Technology Education Series, University of Guelph, Canada). To illustrate the differences in composition between some various types of frozen dairy dessert mixes, sample compositions from this reference are shown below in Tables 1-6.

TABLE 1
Sample suggested mix composition for hard frozen ice cream product

| Component | % by weight |
|---|---|
| Milkfat | 10.0 |
| Milk solids-not-fat¹ | 11.0 |
| Sucrose | 10.0 |
| Corn Syrup Solids | 5.0 |
| Stabilizer | 0.35 |
| Emulsifier | 0.15 |
| Water | 63.5 |

¹Proteins are a component of this phase along with other species contributed by the milk such as lactose and salts. The protein content of the milk solids-not-fat is on average 38% (http://www.uoguelph.ca/foodscience/dairy-science-and-technology/dairy-products/ice-cream/ice-cream-formulations/ice-cream-mix-general-c (Professor H. Douglas Goff, Dairy Science and Technology Education Series, University of Guelph, Canada))., Based on this value, the protein content of the above ice cream mix is approximately 4.18% by weight.

TABLE 2
Sample suggested mix composition for low fat ice cream product

| Component | % by weight |
|---|---|
| Milkfat | 3.0 |
| Milk solids-not-fat¹ | 13.0 |
| Sucrose | 11.0 |
| Corn Syrup Solids | 6.0 |
| Stabilizer | 0.35 |
| Emulsifier | 0.10 |
| Water | 66.35 |

¹Based on a milk solids-not-fat protein content of 38%, the protein content of the above low fat ice cream mix is approximately 4.94% by weight.

TABLE 3
Sample suggested mix composition for light ice cream product

| Component | % by weight |
|---|---|
| Milkfat | 6.0 |
| Milk solids-not-fat¹ | 12.0 |
| Sucrose | 13.0 |
| Corn Syrup Solids | 4.0 |
| Stabilizer | 0.35 |
| Emulsifier | 0.15 |
| Water | 64.5 |

¹Based on a milk solids-not-fat protein content of 38%, the protein content of the above light ice cream mix is approximately 4.56% by weight.

TABLE 4
Sample suggested mix composition for soft frozen ice cream product

| Component | % by weight |
|---|---|
| Milkfat | 10.0 |
| Milk solids-not-fat¹ | 12.5 |
| Sucrose | 13.0 |
| Stabilizer | 0.35 |
| Emulsifier | 0.15 |
| Water | 64.0 |

¹Based on a milk solids-not-fat protein content of 38%, the protein content of the above ice cream mix is approximately 4.75% by weight.

TABLE 5
Sample suggested mix composition for sherbet¹

| Component | % by weight |
|---|---|
| Milkfat | 0.5 |
| Milk solids-not-fat² | 2.0 |
| Sucrose | 24.0 |
| Corn Syrup Solids | 9.0 |
| Stabilizer/Emulsifier | 0.30 |
| Citric acid (50% sol.)³ | 0.70 |
| Water | 63.5 |

¹Fruit is added at about 25% to the mix.
²Based on a milk solids-not-fat protein content of 38%, the protein content of the above sherbet mix is approximately 0.76% by weight.
³Acid s added just before freezing, after aging of the mix

TABLE 6
Sample suggested mix composition for frozen yogurt

| Component | % by weight |
|---|---|
| Milkfat | 2.0 |
| Milk solids-not-fat¹ | 14.0 |
| Sugar | 15.0 |
| Stabilizer | 0.35 |
| Water | 68.65 |

¹Based on a milk solids-not-fat protein content of 38%, the protein content of the above frozen yogurt mix is approximately 5.32% by weight.

As mentioned above, the proportion of components in dairy analogue or plant/dairy blend frozen dessert mixes, may vary similarly to the proportions of components in frozen dairy dessert mixes. Frozen dairy dessert mixes utilize dairy sources of fat and protein/solids. Dairy analogue frozen dessert mixes are entirely plant based, while plant/dairy blends utilize a combination of plant and dairy ingredients.

The typical types of ingredients used in dairy analogue or plant/dairy blend frozen dessert mix formulations are described below. Other types of ingredients not mentioned may also be used in such frozen dessert mix formulations.

The fat source used for the frozen dessert mixes may be any convenient food grade dairy or plant derived fat source or blend of fat sources. Suitable fat sources include but are not limited to milk, cream, butteroil, soy milk, soy oil, coconut oil and palm oil. It should be noted that certain ingredients may provide multiple components to the formulations. For example, the inclusion of milk or soymilk in the formulation provides fat, protein, other solids and water. The fat level in the frozen dessert mixes may range from about 0 to about 30 wt %, preferably about 0 to about 18 wt %.

The protein source used for the frozen dessert mixes may be any convenient food grade dairy or plant derived protein source or blend of protein sources. Suitable protein sources include but are not limited to cream, milk, skim milk powder, whey protein concentrate, whey protein isolate, soy protein concentrate and soy protein isolate. As mentioned above, certain ingredients may provide multiple components, including protein to the formulation. The protein level in the frozen dessert mixes may range from about 0.1 to about 18 wt %, preferably about 0.1 to about 6 wt %.

The choice and level of sweetener or sweeteners used in the frozen dessert mixes will influence factors such as the sweetness, caloric value, and texture of the frozen dessert product. Various sweeteners may be utilized in the frozen dessert mixes, including but not limited to sucrose, corn starch derived ingredients, sugar alcohols, sucralose and acesulfame potassium. Blends of sweeteners are often used to get the desired qualities in the final product. The overall level of added sweetener in the frozen dessert mixes may range from about 0 to about 45 wt %, preferably about 0 to about 35 wt %.

Stabilizers used in the frozen dessert mixes may include but are not limited to locust bean gum, guar gum, carrageenan, carboxymethyl cellulose and gelatin. The stabilizer level in the frozen dessert mixes may be about 0% to about 3%, preferably about 0% to about 1%.

Emulsifiers used in the frozen dessert mixes may include but are not limited to egg yolk, monoglycerides, diglycerides and polysorbate 80. The emulsifier level in the frozen dessert mixes may range from about 0% to about 4%, preferably about 0% to about 2%.

In the present invention, the canola protein product described above is incorporated in the dairy analogue or plant/dairy blend frozen dessert mix to supply at least a portion of the required protein and solids.

### GENERAL DESCRIPTION OF THE INVENTION

The initial step of the process of providing the canola protein product used herein involves solubilizing proteinaceous material from canola oil seed or canola oil seed meal. The proteinaceous material recovered from the canola seed or meal may be the protein naturally occurring in canola seed or the proteinaceous material may be a protein modified by genetic manipulation but possessing characteristic hydrophobic and polar properties of the natural protein. The canola meal may be any canola meal resulting from the removal of canola oil from canola oil seed with varying levels of non-denatured protein, resulting, for example, from hot hexane extraction or cold oil extrusion methods. When canola seeds are used as the protein source, they must first be ground to provide a ground mass of canola seeds. The proteinaceous material may then be solubilized from the ground canola oil seeds. Alternatively, the seeds may be ground wet, using any convenient equipment, such as a high shear pump, to simultaneously grind the seed and solubilize the protein. The recovery of canola protein isolate from canola seeds is more particularly described in copending U.S. application Ser. No. 12/542,931 filed Aug. 28, 2009 (US Patent Publication No. 2010-0041871 published Feb. 18, 2010) and Ser. No. 12/787,465 filed Mar. 22, 2011 (US Patent Publication No. 2011-018149, published Jul. 28, 2011), assigned to the assignee hereof and the disclosures of which are incorporated herein by reference.

Protein solubilization is effected most efficiently by using a food grade salt solution since the presence of the salt enhances the removal of soluble protein from the ground oilseeds or the oil seed meal. The salt usually is sodium chloride, although other salts, such as, potassium chloride, may be used. The salt solution has an ionic strength of at least about 0.05, preferably at least about 0.10, to enable solubilization of significant quantities of protein to be effected. As the ionic strength of the salt solution increases, the degree of solubilization of protein initially increases until a maximum value is achieved. Any subsequent increase in ionic strength does not increase the total protein solubilized. The ionic strength of the food grade salt solution which causes maximum protein solubilization varies depending on the salt concerned and if the protein source is oil seed meal, the oil seed meal chosen.

In view of the greater degree of dilution required for protein precipitation with increasing ionic strengths, it is usually preferred to utilize an ionic strength value less than about 0.8, and more preferably a value of about 0.1 to about 0.15.

In a batch process, the salt solubilization of the protein is effected at a temperature of from about 1° C. to about 75° C., preferably about 15° to about 65° C., more preferably about 20° to about 35° C., preferably accompanied by agitation to decrease the solubilization time, which is usually about 1 to about 60 minutes. It is preferred to effect the solubilization to extract substantially as much protein from the oil seeds or oil seed meal as is practicable, so as to provide an overall high product yield.

In a continuous process, the extraction of the protein from the canola oil seed or meal is carried out in any manner consistent with effecting a continuous extraction of protein from the canola oil seed or meal. In one embodiment, the ground canola oil seed or canola oil seed meal is continuously mixed with a food grade salt solution and the mixture is conveyed through a pipe or conduit having a length and at a flow rate for a residence time sufficient to effect the desired extraction in accordance with the parameters described herein. In such continuous procedure, the salt solubilization step is effected, in a time of up to about 1 minute to about 60 minutes, preferably to effect solubilization to extract substantially as much protein from the canola oil seed or meal as is practicable. The solubilization in the continuous procedure is effected at temperatures between about 1° C. and about 75° C., preferably between about 15° C. and about 65° C., more preferably between about 20° and about 35° C.

The aqueous food grade salt solution generally has a pH of about 5 to about 6.8, preferably about 5.3 to about 6.2. The pH of the salt solution may be adjusted to any desired value within the range of about 5 to about 6.8 for use in the extraction step by the use of any convenient acid, usually hydrochloric acid, or alkali, usually sodium hydroxide, as required.

The concentration of ground oil seeds or oil seed meal in the food grade salt solution during the solubilization step may vary widely. Typical concentration values for ground oil seeds are about 5 to about 25% w/v. Typical concentration values for oil seed meal are about 5 to about 15% w/v.

The protein extraction step with the aqueous salt solution has the additional effect of solubilizing fats which are present in the canola oil seeds and may be present in the canola meal, which then results in the fats being present in the aqueous phase.

The protein solution resulting from the extraction step generally has a protein concentration of about 3 to about 40 g/L, preferably about 10 to about 30 g/L.

The aqueous salt solution may contain an antioxidant. The antioxidant may be any convenient antioxidant, such as sodium sulfite or ascorbic acid. The quantity of antioxidant employed may vary from about 0.01 to about 1 wt % of the solution, preferably about 0.05 wt %. The antioxidant serves to inhibit oxidation of phenolics in the protein solution.

The aqueous phase resulting from the extraction step then may be separated from the residual canola seed material or meal, in any convenient manner, such as by employing a decanter centrifuge, followed by disc centrifugation and/or filtration to remove residual seed material or meal. The separation step is typically conducted at the same temperature as the extraction step but may be conducted at any temperature within the range of about 1° to about 75° C., preferably about 15° to about 65° C., more preferably about 20° to about 35° C. The separated residual seed material or meal may be dried for disposal or further processed to recover residual protein. Residual protein may be recovered by re-extracting the separated residual seed material or meal, with fresh salt solution and the protein solution yielded upon clarification combined with the initial protein solution for further processing as described below. Alternatively, the separated residual seed material or meal may be processed by an isoelectric precipitation procedure or any other convenient procedure to recover residual protein.

The aqueous canola protein solution may be treated with an anti-foamer, such as any suitable food-grade, non-silicone based anti-foamer, to reduce the volume of foam formed upon further processing. The quantity of anti-foamer employed is generally greater than about 0.0003% w/v. Alternatively, the anti-foamer in the quantity described may be added in the extraction steps.

The fat present in the aqueous canola protein solution may be removed by a procedure as described in U.S. Pat. Nos. 5,844,086 and 6,005,076, assigned to the assignee hereof and the disclosures of which are incorporated herein by reference.

As described therein, the aqueous canola protein solution may be chilled to a temperature of about 3° to about 7° C., to cause fat to separate from the aqueous phase for removal by any convenient procedure, such as by decanting. Alternatively, the fat may be removed by any other convenient procedure, such as by centrifugation at higher temperatures using a cream separator. Once the fat has been removed, the aqueous canola protein solution may be further clarified by filtration. The canola oil recovered from the aqueous canola protein solution may be processed to use in commercial applications of canola oil.

Alternatively, the aqueous canola protein solution may be simultaneously separated from the oil phase and the residual canola seed material or meal by any convenient procedure, such as using a three phase decanter. The aqueous canola protein solution may then be further clarified by filtration.

The aqueous canola protein solution may be treated with an adsorbent, such as powdered activated carbon or granulated activated carbon, to remove colour and/or odour compounds. Such adsorbent treatment may be carried out under any convenient conditions, generally at the ambient temperature of the separated aqueous protein solution. For powdered activated carbon, an amount of about 0.025% to about 5% w/v, preferably about 0.05% to about 2% w/v, is employed. The adsorbing agent may be removed from the canola protein solution by any convenient mean, such as filtration.

As an alternative to extracting the ground canola oil seed or oil seed meal with an aqueous salt solution, such extraction may be made using water alone, although the utilization of water alone tends to extract less protein from the ground oil seed or oil seed meal than the aqueous salt solution. Where such alternative is employed, then the salt, in the concentrations discussed above, may be added to the protein solution after separation from the residual ground seed material or oil seed meal and if utilized, the fat removal step in order to maintain the protein in solution during the concentration step described below.

Another alternative procedure is to extract the ground oil seeds or oil seed meal with the food grade salt solution at a relatively high pH value above about 6.8, generally up to about 9.9. The pH of the food grade salt solution may be adjusted to the desired alkaline value by the use of any convenient food-grade alkali, such as aqueous sodium hydroxide solution. Alternatively, the ground oil seeds or oil seed meal may be extracted with the salt solution at a relatively low pH below about pH 5, generally down to about pH 3. Where such alternative is employed, the aqueous phase resulting from the extraction step then is separated from the residual canola seed material or meal, and if necessary, defatted as described above.

The aqueous protein solution resulting from the high or low pH extraction step then is pH adjusted to the range of about 5 to about 6.8, preferably about 5.3 to about 6.2, as discussed above, prior to further processing as discussed below. Such pH adjustment may be effected using any convenient acid, such as hydrochloric acid, or alkali, such as sodium hydroxide, as appropriate.

The aqueous canola protein solution is concentrated to increase the protein concentration thereof while maintaining the ionic strength thereof substantially constant. Such concentration generally is effected to provide a concentrated protein solution having a protein concentration of at least about 50 g/L, preferably at least about 200 g/L, more preferably at least about 250 g/L.

The concentration step may be effected in any convenient manner consistent with batch or continuous operation, such as by employing any convenient selective membrane technique, such as ultrafiltration or diafiltration, using membranes, such as hollow-fibre membranes or spiral-wound membranes, with a suitable molecular weight cut-off, such as about 3,000 to about 100,000 Daltons, preferably about 5,000 to about 10,000 Daltons, having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass through the membrane while preventing higher molecular weight species from so doing. The low molecular weight species include not only the ionic species of the food grade salt but also low molecular weight materials extracted from the source material, such as, carbohydrates, pigments and anti-nutritional factors, as well as any low molecular weight forms of the protein. The molecular weight cut-off of the membrane is usually chosen to ensure retention of a significant proportion of the protein in the solution, while permitting contaminants to pass through having regard to the different membrane materials and configurations.

The concentrated protein solution then may be subjected to a diafiltration step using an aqueous salt solution of the same molarity and pH as the extraction solution. Such diafiltration may be effected using from about 1 to about 20 volumes of diafiltration solution, preferably about 5 to about 10 volumes of diafiltration solution. In the diafiltration operation, further quantities of contaminants are removed from the aqueous canola protein solution by passage through the membrane with the permeate. The diafiltration operation may be effected until no significant further quantities of contaminants or visible colour are present in the permeate. Such diafiltration may be effected using the same membrane as for the concentration step. However, if desired, the diafiltration step may be effected using a separate membrane with a different molecular weight cut-off, such as a membrane having a molecular weight cut-off in the range of about 3,000 to about 100,000 Daltons, preferably about 5,000 to about 10,000 Daltons, having regard to different membrane materials and configuration.

Alternatively, the diafiltration step may be applied to the aqueous canola protein solution prior to concentration or to partially concentrated aqueous canola protein solution having a protein concentration of about 50 g/L or less. Diafiltration may also be applied at multiple points during the concentration process. When diafiltration is applied prior to concentration or to the partially concentrated solution, the resulting diafiltered solution is then additionally concentrated.

An antioxidant may be present in the diafiltration medium during at least part of the diafiltration step. The antioxidant may be any convenient antioxidant, such as sodium sulfite or ascorbic acid. The quantity of antioxidant employed in the diafiltration medium depends on the materials employed and may vary from about 0.01 to about 1 wt %, preferably about 0.05 wt %. The antioxidant serves to inhibit oxidation of phenolics present in the canola protein solution.

The concentration step and the diafiltration step may be effected at any convenient temperature, generally about 2° to about 65° C., preferably about 20 to about 35° C., and for the period of time to effect the desired degree of concentration and diafiltration. The temperature and other conditions used to some degree depend upon the membrane equipment used to effect the concentration and the desired protein concentration of the solution.

The concentrated and optionally diafiltered protein solution may be subject to a further defatting operation, if required, as described in U.S. Pat. Nos. 5,844,086 and 6,005,076. Alternatively, the concentrated and optionally diafiltered protein solution may be further defatted by any other convenient procedure.

The concentrated and optionally diafiltered protein solution may be treated with an adsorbent, such as powdered activated carbon or granulated activated carbon, to remove colour and/or odour compounds. Another material which may be used as a colour adsorbing agent is polyvinylpyrrolidone.

Such adsorbent treatment may be carried out under any convenient conditions, generally at the ambient temperature of the canola protein solution. For powdered activated carbon, an amount of about 0.025% to about 5% w/v, preferably about 0.05% to about 2% w/v, may be used. Where polyvinylpyrrolidone is used as the colour adsorbing agent, an amount of about 0.5% to about 5% w/v, preferably about 2% to about 3% w/v, may be used. The adsorbent may be removed from the canola protein solution by any convenient means, such as by filtration.

The concentrated and optionally diafiltered protein solution resulting from the optional colour removal step may be subjected to pasteurization to reduce the microbial load. Such pasteurization may be effected under any desired pasteurization conditions. Generally, the concentrated and optionally diafiltered protein solution is heated to a temperature of about 55° to about 70° C., preferably about 60° to about 65° C., for about 30 seconds to about 60 minutes, preferably about 10 to about 15 minutes. The pasteurized concentrated protein solution then may be cooled for further processing as described below, preferably to a temperature of about 25° to about 40° C.

Depending on the temperature employed in the concentration step and optional diafiltration step and whether or not a pasteurization step is effected, the concentrated protein solution may be warmed to a temperature of at least about 20°, and up to about 60° C., preferably about 25° to about 40° C., to decrease the viscosity of the concentrated protein solution to facilitate performance of the subsequent dilution step and micelle formation. The concentrated protein solution should not be heated beyond a temperature above which micelle formation does not occur on dilution by chilled water.

The concentrated protein solution resulting from the concentration step, and optional diafiltration step, optional defatting step, optional colour removal step and optional pasteurization step, then is diluted to effect micelle formation by mixing the concentrated protein solution with chilled water having the volume required to achieve the degree of dilution desired. Depending on the proportion of canola protein desired to be obtained by the micelle route and the proportion from the supernatant, the degree of dilution of the concentrated protein solution may be varied. With lower dilution levels, in general, a greater proportion of the canola protein remains in the aqueous phase.

When it is desired to provide the greatest proportion of the protein by the micelle route, the concentrated protein solution is diluted by about 5 fold to about 25 fold, preferably by about 10 fold to about 20 fold.

The chilled water with which the concentrated protein solution is mixed has a temperature of less than about 15° C., generally about 1° to about 15° C., preferably less than about 10° C., since improved yields of protein isolate in the form of protein micellar mass are attained with these colder temperatures at the dilution factors used.

In a batch operation, the batch of concentrated protein solution is added to a static body of chilled water having the desired volume, as discussed above. The dilution of the concentrated protein solution and consequential decrease in ionic strength causes the formation of a cloud-like mass of highly associated protein molecules in the form of discrete protein droplets in micellar form. In the batch procedure, the protein micelles are allowed to settle in the body of chilled water to form an aggregated, coalesced, dense, amorphous sticky gluten-like protein micellar mass (PMM). The settling may be assisted, such as by centrifugation. Such induced settling decreases the liquid content of the protein micellar mass, thereby decreasing the moisture content generally from about 70% by weight to about 95% by weight to a value of generally about 50% by weight to about 80% by weight of the total micellar mass. Decreasing the moisture content of the micellar mass in this way also decreases the occluded salt content of the micellar mass, and hence the salt content of the dried isolate.

Alternatively, the dilution operation may be carried out continuously by continuously passing the concentrated protein solution to one inlet of a T-shaped pipe, while the diluting water is fed to the other inlet of the T-shaped pipe, permitting mixing in the pipe. The diluting water is fed into the T-shaped pipe at a rate sufficient to achieve the desired degree of dilution of the concentrated protein solution.

The mixing of the concentrated protein solution and the diluting water in the pipe initiates the formation of protein micelles and the mixture is continuously fed from the outlet from the T-shaped pipe into a settling vessel, from which, when full, supernatant is permitted to overflow. The mixture preferably is fed into the body of liquid in the settling vessel in a manner which minimizes turbulence within the body of liquid.

In the continuous procedure, the protein micelles are allowed to settle in the settling vessel to form an aggregated, coalesced, dense, amorphous, sticky, gluten-like protein micellar mass (PMM) and the procedure is continued until a desired quantity of the PMM has accumulated in the bottom of the settling vessel, whereupon the accumulated PMM is removed from the settling vessel. In lieu of settling by sedimentation, the PMM may be separated continuously by centrifugation.

By the utilization of a continuous process for the recovery of canola protein isolate as compared to the batch process there is less chance of contamination, leading to higher product quality and the process can be carried out in more compact equipment.

The settled PMM is separated from the residual aqueous phase or supernatant, such as by decantation of the residual aqueous phase from the settled mass or by centrifugation. The PMM may be used in the wet form or may be dried, by any convenient technique, such as spray drying or freeze drying, to a dry form. The dry PMM has a high protein content, in excess of about 90 wt % (N×6.25) d.b., preferably at least about 100 wt % (N×6.25) d.b., and is substantially undenatured (as determined by differential scanning calorimetry).

As described in the aforementioned U.S. Pat. No. 7,662,922, assigned to the assignee hereof and the disclosures of which are incorporated herein by reference, the PMM consists predominantly of a 7S canola protein, having a protein component composition of about 60 to 98 wt % of 7S protein, about 1 to about 15 wt % of 12S protein and 0 to about 25 wt % of 2S protein.

The supernatant from the PMM formation and settling step contains significant amounts of canola protein, not precipitated in the dilution step, and is processed to recover canola protein products therefrom.

As described in U.S. Pat. No. 7,687,087, the supernatant from the dilution step, following removal of the PMM, may be concentrated to increase the protein concentration thereof. Such concentration is effected using any convenient selective membrane technique, such as ultrafiltration, using membranes with a suitable molecular weight cut-off permitting low molecular weight species, including salt, carbohydrates, pigments and other low molecular weight materials extracted from the source material, to pass through the membrane, while retaining a significant proportion of the canola protein in the solution. Ultrafiltration membranes having a molecular weight cut-off of about 3,000 to about 100,000 Daltons, preferably about 5,000 to about 10,000 Daltons, having regard to differing membrane materials and configurations, may be used. Concentration of the supernatant in this way also reduces the volume of liquid required to be dried to recover the protein, and hence the energy required for drying. The supernatant generally is concentrated to a protein content of at least about 50 g/L, preferably about 100 to 400 g/L, more preferably about 200 to about 300 g/L.

The concentrated supernatant then may be subjected to a diafiltration step using water, saline or acidified water. Such diafiltration may be effected using from about 1 to about 20 volumes of diafiltration solution, preferably about 5 to about 10 volumes of diafiltration solution. In the diafiltration operation, further quantities of contaminants are removed from the aqueous supernatant by passage through the membrane with the permeate. The diafiltration operation may be effected until no significant further quantities of contaminants or visible colour are present in the permeate. Such diafiltration may be effected using the same membrane as for the concentration step. However, if desired, the diafiltration may be effected using a separate membrane, such as a membrane having a molecular weight cut-off in the range of about 3,000 to about 100,000 Daltons, preferably about 5,000 to about 10,000 Daltons, having regard to different membrane materials and configuration.

Alternatively, the diafiltration step may be applied to the supernatant prior to concentration or to partially concentrated supernatant having a protein concentration of about 50 g/L or less. Diafiltration may also be applied at multiple points during the concentration process. When diafiltration is applied prior to concentration or to the partially concentrated supernatant, the resulting diafiltered solution may then be additionally concentrated.

The concentration step and the diafiltration step may be effected herein in such a manner that the canola protein product subsequently recovered contains less than about 90 wt % (N×6.25) d.b., such as at least about 60 wt % protein (N×6.25) d.b. By partially concentrating and/or partially diafiltering the aqueous canola protein solution, it is possible to only partially remove contaminants. This protein solution may then be dried to provide a canola protein product with lower levels of purity.

An antioxidant may be present in the diafiltration medium during at least part of the diafiltration step. The antioxidant may be any convenient antioxidant, such as sodium sulfite or ascorbic acid. The quantity of antioxidant employed in the diafiltration medium depends on the materials employed and may vary from about 0.01 to about 1 wt %, preferably about 0.05 wt %. The antioxidant serves to inhibit oxidation of phenolics present in the canola protein solution.

The concentrated and optionally diafiltered protein solution may be subject to a colour removal operation as an alternative to the colour removal operation described above. Powdered activated carbon may be used herein as well as granulated activated carbon (GAC). Another material which may be used as a colour adsorbing agent is polyvinyl pyrrolidone.

The colour adsorbing agent treatment step may be carried out under any convenient conditions, generally at the ambient temperature of the canola protein solution. For powdered activated carbon, an amount of about 0.025% to about 5% w/v, preferably about 0.05% to about 2% w/v, may be used. Where polyvinylpyrrolidone is used as the colour adsorbing agent, an amount of about 0.5% to about 5% w/v, preferably about 2% to about 3% w/v, may be used. The colour adsorbing agent may be removed from the canola protein solution by any convenient means, such as by filtration.

The concentrated and optionally diafiltered supernatant may be dried by any convenient technique, such as spray drying or freeze drying, to a dry form to provide a canola protein product. Such canola protein product has a protein content in excess of about 60 wt % (N×6.25) d.b., preferably the canola protein product is an isolate having a protein content in excess of about 90 wt % (N×6.25) d.b., more preferably in excess of about 100 wt % (N×6.25) d.b. and is substantially undenatured (as determined by differential scanning calorimetry).

As described in the aforementioned U.S. Pat. No. 7,662,922, the supernatant derived canola protein isolate consists predominantly of 2S canola protein, having a protein component composition of about 60 to about 95 wt % of 2S protein, about 5 to about 40 wt % of a 7S protein and 0 to about 5 wt % of 12S protein.

Alternatively, the supernatant from the separation of the PMM may be processed by alternative procedures to recover canola protein product therefrom. For example, as described in copending U.S. patent application Ser. No. 12/213,500 filed Jun. 20, 2008 (US Patent Publication No. 2008-0299282 published Dec. 4, 2008), assigned to the assignee hereof and the disclosures of which are incorporated herein by reference, the concentrated supernatant may be heat treated to precipitate 7S protein therefrom prior to recovery of the canola protein product from the heat-treated solution.

Such heat treatment may be effected using a temperature and time profile sufficient to decrease the proportion of 7S protein present in the concentrated supernatant, preferably to reduce the proportion of 7S protein by a significant extent. In general, the 7S protein content of the concentrated supernatant is reduced by at least about 50 wt %, preferably at least about 75 wt % by the heat treatment. In general, the heat treatment may be effected at a temperature of about 70° to about 120° C., preferably about 75° to about 105° C., for about 1 second to about 30 minutes, preferably about 5 to about 15 minutes. The precipitated 7S protein may be removed in any convenient manner, such as centrifugation or filtration or a combination thereof.

The heat-treated concentrated supernatant, after removal of the precipitated 7S protein, may be acidified prior to drying, to a pH corresponding to the intended use of the dried isolate, generally a pH down to about 2 to about 5, preferably about 2.5 to about 4.

The heat-treated concentrated supernatant, after removal of the precipitated 7S protein, may be dried by any convenient technique, such as spray drying or freeze drying, to a dry form to provide a canola protein product. Such canola protein product has a protein content in excess of about 60 wt % (N×6.25) d.b., preferably the product is a canola protein isolate having a protein content, in excess of about 90 wt % (N×6.25) d.b., more preferably in excess of about 100 wt % protein (N×6.25) d.b. and is substantially undenatured (as determined by differential scanning calorimetry).

Such novel canola protein product contains a high proportion of 2S protein, preferably at least 90 wt % and more preferably at least about 95 wt %, of the canola protein in the product. There is also a proportion of 7S protein in the product.

Alternatively, the heat treatment step to precipitate 7S protein, as described above, may be effected on the supernatant prior to the concentration and diafiltration steps mentioned above. Following removal of the deposited 7S protein, the supernatant may be concentrated, generally to a protein concentration of about 50 to about 400 g/L, preferably about 200 to about 300 g/L, optionally diafiltered, optionally submitted to a colour removal operation, and dried to provide the canola protein product.

As a further alternative, the supernatant first may be partially concentrated to a protein concentration of about 50 g/L or less. The partially concentrated supernatant then is subjected to the heat treatment to precipitate 7S protein, as described above. Following removal of the precipitated 7S protein, the supernatant may be further concentrated, generally to a concentration of about 50 to about 400 g/L, preferably about 200 to about 300 g/L, optionally diafiltered, optionally submitted to a colour removal operation, and dried to provide the canola protein product.

Precipitated 7S protein is removed from the heat treated supernatant or heat treated partially concentrated supernatant by any convenient means, such as centrifugation or filtration or a combination thereof.

Following removal of precipitated 7S protein, the heat treated supernatant or heat treated partially concentrated supernatant may be acidified at any point during or after concentration or diafiltration, as discussed above.

As also described in U.S. patent application Ser. No. 12/213,500, the supernatant from the micelle formation and precipitation may be processed in an alternative manner to form the canola protein product. The supernatant may further be first concentrated or partially concentrated, as discussed above.

A salt, usually sodium chloride, although other salts such as potassium chloride may be used, first is added to the supernatant, partially concentrated supernatant or concentrated supernatant to provide a salinated solution having a conductivity of at least about 0.3 mS, preferably about 10 to about 20 mS.

The pH of the salinated supernatant is adjusted to a value to cause isoelectric precipitation of 7S protein, generally to a pH of about 2.0 to about 4.0, preferably about 3.0 to about 3.5. The isoelectric precipitation of the 7S protein may be effected over a wide temperature range, generally from about 5° C. to about 70° C., preferably about 10° C. to about 40° C. The precipitated 7S protein is removed from the isoelectrically precipitated supernatant by any convenient means, such as centrifugation or filtration or a combination thereof.

The isoelectrically precipitated supernatant, if not already concentrated, then may be concentrated as discussed above and diafiltered to remove the salt, prior to drying to form the canola protein product of the invention. The concentrated and diafiltered supernatant may be filtered to remove residual particulates and subjected to an optional colour removal step, as discussed above, prior to drying by any convenient technique, such as spray drying or freeze drying, to a dry form to provide the canola protein product of the invention. Such canola protein product has a protein content in excess of about 60 wt % (N×6.25) d.b., preferably the product is a canola protein isolate having a protein content in excess of about 90 wt % (N×6.25) d.b., more preferably in excess of about 100 wt % protein (N×6.25) d.b.

In another alternative procedure, a calcium salt, preferably calcium chloride, is added to the supernatant from the separation of the PMM, which may first be concentrated or partially concentrated in the manner described below, to provide a conductivity of about 5 mS to about 30 mS, preferably 8 mS to about 10 mS. The calcium chloride added to the supernatant, partially concentrated supernatant or concentrated supernatant may be in any desired form, such as a concentrated aqueous solution thereof.

The addition of the calcium chloride has the effect of depositing phytic acid, in the form of calcium phytate, from the supernatant, partially concentrated supernatant or concentrated supernatant while retaining both the globulin and albumin protein fractions in solution. The deposited phytate is recovered from the supernatant, partially concentrated supernatant or concentrated supernatant, such as by centrifugation and/or filtration to leave a clear solution. If desired, the deposited phytate may not be removed in which case the further processing results in a product having a higher phytate content.

The pH of the solution then is adjusted to a value of about 2.0 to about 4.0, preferably about 2.9 to 3.2. The pH adjustment may be effected in any convenient manner, such as by the addition of hydrochloric acid. If desired, the acidification step may be omitted from the various options described herein.

The pH-adjusted clear solution, if not already concentrated, may be concentrated to increase the protein concentration thereof. Such concentration is effected using any convenient selective membrane technique, such as ultrafiltration, using membranes with a suitable molecular weight cut-off permitting low molecular weight species, including salt, carbohydrates, pigments and other low molecular weight materials extracted from the protein source material, to pass through the membrane, while retaining a significant proportion of the canola protein in the solution. Ultrafiltration membranes having a molecular weight cut-off of about 3,000 to 100,000 Daltons, preferably about 5,000 to about 10,000 Daltons, having regard to differing membrane materials and configuration, may be used. Concentration of the solution in this way also reduces the volume of liquid required to be dried to recover the protein. The solution generally may be concentrated to a protein concentration of at least about 50 g/L, preferably about 50 to about 500 g/L, more preferably about 100 to about 250 g/L, prior to drying. Such concentration operation may be carried out in a batch mode or in a continuous operation, as described above.

Where the supernatant is partially concentrated prior to the addition of the calcium salt, the supernatant is first concentrated to a protein concentration of about 50 g/L or less, and, after removal of the precipitate, then may be concentrated to a concentration of at least about 50 g/L, preferably about 50 to about 500 g/L, more preferably about 100 to about 250 g/L.

In another alternative procedure, the calcium salt may be added in two stages. In this procedure, a small amount of calcium is added to the supernatant to provide a conductivity of about 1 mS to about 3.5 mS, preferably about 1 mS to about 2 mS, which is insufficient to cause the formation of a precipitate.

The resulting solution is acidified and partially concentrated under the conditions described above. The balance of the calcium salt is added to the partially concentrated solution to provide a conductivity of about 4 mS to about 30 mS, preferably about 4 to about 10 mS, to result in the formation of a precipitate. The precipitate then is removed. The resulting clear solution then is concentrated under the conditions described above.

The concentrated calcium treated supernatant then may be subjected to a diafiltration step using water. The water may be at its natural pH, a pH equal to the protein solution being diafiltered or any pH in between. Such diafiltration may be effected using from about 1 to about 20 volumes of diafiltration solution, preferably about 5 to about 10 volumes of diafiltration solution. In the diafiltration operation, further quantities of contaminants are removed from the aqueous supernatant by passage through the membrane with the permeate. The diafiltration operation may be effected until no significant further quantities of contaminants or visible colour are present in the permeate. Such diafiltration may be effected using the same membrane as for the concentration step. However, if desired, the diafiltration may be effected using a separate membrane, such as a membrane having a molecular weight cut-off in the range of about 3,000 to about 100,000 Daltons, preferably about 5,000 to about 10,000 Daltons, having regard to different membrane materials and configuration.

An antioxidant may be present in the diafiltration medium during at least part of the diafiltration step. The antioxidant may be any convenient antioxidant, such as sodium sulfite or ascorbic acid. The quantity of antioxidant employed in the diafiltration medium depends on the materials employed and may vary from about 0.01 to about 1 wt %, preferably about 0.05 wt %. The antioxidant serves to inhibit oxidation of phenolics present in the concentrated canola protein solution.

The concentrated and optionally diafiltered protein solution may be subjected to a colour removal operation. Powdered activated carbon may be used herein as well as granulated activated carbon (GAC). Another material which may be used as a colour adsorbing agent is polyvinyl pyrrolidone.

The colour adsorbing agent treatment step may be carried out under any convenient conditions, generally at the ambient temperature of the canola protein solution. For powdered activated carbon, an amount of about 0.025% to about 5% w/v, preferably about 0.05% to about 2% w/v, may be used. Where polyvinylpyrrolidone is used as the colour adsorbing agent, an amount of about 0.5% to about 5% w/v, preferably about 2% to about 3% w/v, may be used. The colour adsorbing agent may be removed from the canola protein solution by any convenient means, such as by filtration.

The concentrated and optionally diafiltered and optionally adsorbent treated protein solution is dried by any convenient technique, such as spray drying or freeze drying, to a dry form. The dried canola protein product has a protein content in excess of about 60 wt % (N×6.25) d.b., preferably the product is a canola protein isolate having a protein content in excess of about 90 wt % (N×6.25) d.b., more preferably in excess of about 100 wt % (N×6.25) d.b., and is substantially undenatured (as determined by differential scanning calorimetry). The canola protein product generally is low in phytic acid content, generally less than about 1.5% by weight.

The canola protein product produced herein contains both albumin and globulin fractions and is soluble in an acidic aqueous environment.

Canola protein products derived from the supernatant of the PMM settling step, prepared by any of the above described procedures, are suitable for use in dairy analogue or plant/dairy frozen dessert mixes, used to prepare frozen dessert products, as described above.

### EXAMPLES

### Example 1

This Example illustrates the production of a canola protein isolate used for the preparation of a frozen dessert.

100 kg of canola meal was added to 1000 L of 0.15M NaCl solution at ambient temperature and agitated for 30 minutes to provide an aqueous protein solution. The residual canola meal was removed and the resulting protein solution was partially clarified by centrifugation to produce 735.8 L of partially clarified protein solution having a protein content of 1.49% by weight. The partially clarified protein solution was filtered to further clarify the protein solution, resulting in 685 L of solution, having a protein content of 1.37% by weight.

685 L of the filtered protein extract solution was concentrated to 35 L on a polyethersulfone (PES) membrane having a molecular weight cutoff of 100,000 Daltons. The resulting concentrated protein solution had a protein content of 17.88% by weight. The concentrated protein solution was then diafiltered with 150 L of 0.15M NaCl solution. The resulting concentrated and diafiltered solution had a protein content of 19.38% by weight. The concentrated and diafiltered protein solution was then pasteurized at 63° C. for 10 minutes to provide 35.8 kg of pasteurized, concentrated and diafiltered protein solution with a protein content of 19.14% by weight.

35.6 kg of the pasteurized, concentrated and diafiltered protein solution at 30° C. was diluted into 356 L of cold RO water having a temperature of 4.1° C. A white cloud formed immediately. The precipitated protein was separated from the residual aqueous phase, termed the supernatant, by centrifugation. The precipitated, viscous, sticky mass (PMM) was recovered in a yield of 30.8 wt % of the filtered protein solution. The dried PMM derived protein was found to have a protein content of 99.03% (N×6.25) d.b. The product was given a designation SD078-J15-07A C300.

An aliquot of 75 L of supernatant, having a protein content of 1.05 wt %, was reduced in volume to 4.8 L by ultrafiltration using a polyethersulfone (PES) membrane having a molecular weight cut-off of 10,000 Daltons. The concentrated protein solution was then diafiltered on the same membrane with 20 L of reverse osmosis purified (RO) water. The diafiltered, concentrated protein solution contained 15.22% protein by weight. With the additional protein recovered from the supernatant, the overall protein recovery of the filtered protein solution was 38.6 wt %. The diafiltered, concentrated protein solution was then spray dried and given designation SD078-J15-07A C200-01. The C200-01 had a protein content of 96.11% (N×6.25) d.b.

### Example 2

This Example illustrates the production of a frozen dessert used for sensory evaluation. The frozen dessert was produced using the SD076-J15-07A C200-01, prepared as described in Example 1.

Sufficient protein powder to supply 14.4 g of protein was weighed out and approximately 550 ml of purified drinking water was added. The sample was stirred until the protein was completely solubilized. The pH of the solution was adjusted from 5.37 to 6.86 using a solution of food grade NaOH. To the pH adjusted solution was added 7.2 g of canola oil (Canada Safeway Limited, Calgary, AB) and the volume of the sample brought up to 600 ml with additional water. The sample was then processed at 5,000 rpm for 3 minutes on a Silverson L4RT mixer equipped with a fine emulsor screen.

A sample of the canola protein solution (507.16 g) was weighed out and then pure vanilla extract (1.99 g) (Club House, McCormick Canada, London, ON) and granulated sugar (89.85 g) (Rogers, Lantic Inc., Montreal, QC) added and the mixture stirred until the sugar completely dissolved. The pH of the mix was 6.87. The mix was chilled until the temperature reached 9° C. The chilled mix was transferred to the bowl of a Cuisinart ICE-50BCC ice cream maker and the ice cream maker was run for 45 minutes yielding a semisolid frozen dessert. The product was transferred to a plastic tub and stored in a freezer at about −20° C. for one hour until the sensory evaluation was performed.

### Example 3

This Example illustrates sensory evaluation of the frozen dessert prepared in Example 2.

Samples of the frozen dessert were transferred to small cups and presented blindly to an informal panel with 9 panelists. The panel was asked to provide comments regarding the flavor of the frozen dessert. Comments included: “flavour is quite nice”, “good vanilla taste”, “no beaniness detected”, “nice flavour”, “good flavour” and “no aftertaste”.

### Example 4

This Example illustrates the production of a canola protein isolate used for the preparation of the frozen dessert.

172 kg of canola meal was added to 1720 L of 0.15M NaCl solution at ambient temperature and agitated for 30 minutes to provide an aqueous protein solution. The residual canola meal was removed and the resulting protein solution was partially clarified by centrifugation to produce 1358 L of partially clarified protein solution having a protein content of 1.35% by weight. The partially clarified protein solution was filtered to further clarify the protein solution, resulting in 1301 L of solution, having a protein content of 1.18% by weight.

1301 L of the filtered protein extract solution was concentrated to 67.2 kg on a polyvinylidene fluoride (PVDF) membrane having a molecular weight cutoff of 5,000 Daltons. The resulting concentrated protein solution had a protein content of 22.50% by weight. The concentrated protein solution was then pasteurized at 63° C. for 10 minutes to provide 66.8 kg of pasteurized, concentrated protein solution with a protein content of 21.75% by weight.

66.7 kg of the concentrated solution at 27° C. was diluted into 1000.5 L of cold RO water having a temperature of 5° C. A white cloud formed immediately. The precipitated protein was separated from the residual aqueous phase, termed the supernatant, by centrifugation. The precipitated, viscous, sticky mass (PMM) was recovered in a yield of 42.5 wt % of the filtered protein solution. The dried PMM derived protein was found to have a protein content of 101.19% (N×6.25) d.b. The product was given a designation SD076-G03-07A C300.

1050 L of supernatant, having a protein content of 0.76% by weight, was heated to 85° C. for 10 minutes and then centrifuged to remove precipitated protein. 1040 L of this heat treated and clarified protein solution, having a protein content of 0.64 wt %, was reduced in volume to 29.1 L by ultrafiltration using a polyethersulfone (PES) membrane having a molecular weight cut-off of 10,000 Daltons. The concentrated protein solution contained 16.65% protein by weight. With the additional protein recovered from the supernatant, the overall protein recovery of the filtered protein solution was 74.1 wt %. The concentrated protein solution was then spray dried and given designation SD076-G03-07A C200HS. The C200HS had a protein content of 92.56% (N×6.25) d.b.

### Example 5

This Example illustrates the production of a frozen dessert used for sensory evaluation. The frozen dessert was produced using the SD076-G03-07A C200HS, prepared as described in Example 4.

Sufficient protein powder to supply 14.4 g of protein was weighed out and approximately 550 ml of purified drinking water was added. The sample was stirred until the protein was completely solubilized. The pH of the solution was adjusted from 5.62 to 6.90 using a solution of food grade NaOH. To the pH adjusted solution was added 7.2 g of canola oil (Canada Safeway Limited, Calgary, AB) and the volume of the sample brought up to 600 ml with additional water. The sample was then processed at 5,000 rpm for 3 minutes on a Silverson L4RT mixer equipped with a fine emulsor screen.

A sample of the canola protein solution (507.16 g) was weighed out and then pure vanilla extract (1.99 g) (Club House, McCormick Canada, London, ON) and granulated sugar (89.85 g) (Rogers, Lantic Inc., Montreal, QC) added and the mixture stirred until the sugar completely dissolved. The pH of the mix was 6.88. The mix was chilled until the temperature reached 9° C. The chilled mix was transferred to the bowl of a Cuisinart ICE-50BCC ice cream maker and the ice cream maker was run for 45 minutes yielding a semisolid frozen dessert. The product was transferred to a plastic tub and stored in a freezer at about −20° C. for one hour until the sensory evaluation was performed.

### Example 6

This Example illustrates sensory evaluation of the frozen dessert prepared in Example 5.

Samples of the frozen dessert were transferred to small cups and presented blindly to an informal panel with 9 panelists. The panel was asked to provide comments regarding the flavor of the frozen dessert. Comments included: “very sweet”, “pleasant flavour”, “no beany taste”, “very nice, sweet vanilla flavour”, “sweet”, “good vanilla taste with slightly sweet aftertaste”, “no harsh or astringent notes” and “very good”

### Example 7

This Example illustrates the production of a canola protein isolate used for the preparation of the frozen dessert.

143 kg of canola meal was added to 1500 L of 0.15M NaCl solution at ambient temperature and agitated for 30 minutes to provide an aqueous protein solution. The residual canola meal was removed and the resulting protein solution was partially clarified by centrifugation to produce 1148.7 L of partially clarified protein solution having a protein content of 1.36% by weight. The partially clarified protein solution was filtered to further clarify the protein solution, resulting in 1122 L of solution, having a protein content of 1.28% by weight.

1122 L of the filtered protein extract solution was concentrated to 63.74 kg on a polyethersulfone (PES) membrane having a molecular weight cutoff of 100,000 Daltons. The resulting concentrated protein solution had a protein content of 19.64% by weight.

63.34 kg of the concentrated solution at 30° C. was diluted into 950.1 L of cold RO water having a temperature of 2° C. A white cloud formed immediately. The precipitated protein was separated from the residual aqueous phase, termed the supernatant, by centrifugation. The precipitated, viscous, sticky mass (PMM) was recovered in a yield of 51.4 wt % of the filtered protein solution. The dried PMM derived protein was found to have a protein content of 99.54% (N×6.25) d.b. The product was given a designation SD092-D14-09A C307C.

995 L of supernatant was adjusted to conductivity 8.16 mS by the addition of calcium chloride. This solution was then centrifuged to remove precipitated phytate material resulting in 980.6 L of a reduced phytate content, clarified protein solution. The reduced phytate content, clarified protein solution was then adjusted to pH 3.06 by the addition of HCl. 960 L of this acidified, reduced phytate content, clarified protein solution, having a protein content of 0.50 wt %, was reduced in volume to 35 L by ultrafiltration using a polyethersulfone (PES) membrane having a molecular weight cut-off of 10,000 Daltons. The concentrated protein solution was then diafiltered on the same membrane with 170 L of pH 3 reverse osmosis purified (RO) water. The diafiltered, concentrated protein solution contained 10.91% protein by weight. With the additional protein recovered from the supernatant, the overall protein recovery of the filtered protein solution was 79.7 wt %. A 37.27 kg portion of the concentrate was subjected to a colour reduction step by passing it through a 5 L bed volume (BV) of granular activated carbon at a rate of 3 BV/hr at pH 3. The 36.93 kg of GAC treated solution having reduced colour and a protein content of 9.73% by weight was then spray dried and given designation SD092-D14-09A C200CaC. The C200CaC had a protein content of 91.48 (N×6.25) d.b.

### Example 8

This Example illustrates the production of a frozen dessert used for sensory evaluation. The frozen dessert was produced using the SD092-D14-09A C200CaC, prepared as described in Example 7.

Sufficient protein powder to supply 14.4 g of protein was weighed out and approximately 550 ml of purified drinking water was added. The sample was stirred until the protein was completely solubilized. The pH of the solution was adjusted from 3.60 to 6.88 using a solution of food grade NaOH. To the pH adjusted solution was added 7.2 g of canola oil (Canada Safeway Limited, Calgary, AB) and the volume of the sample brought up to 600 ml with additional water. The sample was then processed at 5,000 rpm for 3 minutes on a Silverson L4RT mixer equipped with a fine emulsor screen.

A sample of the canola protein solution (507.16 g) was weighed out and then pure vanilla extract (1.99 g) (Club House, McCormick Canada, London, ON) and granulated sugar (89.85 g) (Rogers, Lantic Inc., Montreal, QC) added and the mixture stirred until the sugar completely dissolved. The mix was then chilled until the temperature reached 9° C. The chilled mix was transferred to the bowl of a Cuisinart ICE-50BCC ice cream maker and the ice cream maker was run for 45 minutes yielding a semisolid frozen dessert having a temperature of about −4.5° C. The product was transferred to a plastic tub and stored in a freezer at about −20° C. for one hour until the sensory evaluation was performed.

### Example 9

This Example illustrates sensory evaluation of the frozen dessert prepared in Example 8.

Samples of the frozen dessert were transferred to small cups and presented blindly to an informal panel with 8 panelists. The panel was asked to provide comments regarding the flavor of the frozen dessert. Comments included: “nice flavour, no beaniness” “nice natural vanilla flavour, good sweetness, slight honey-like note”, “very acceptable flavour overall” and “nice flavour overall”.

### SUMMARY OF THE DISCLOSURE

In summary of this disclosure, dairy analogue or plant/dairy blend frozen dessert mixes used in the production of frozen dessert products with favourable flavour properties are provided using canola protein products. Modifications are possible within the scope of the invention.

What we claim is:

1. A frozen dessert mix having a composition that includes protein, fat, flavourings, sweetener, stabilizers and emulsifiers in sufficient proportions to provide a desired composition of frozen dessert product, wherein the protein component is provided at least in part by a canola protein product having a protein content of at least about 60 wt % (N×6.25) d.b. and consisting predominantly of 2S canola protein and derived from supernatant from a protein micellar mass settling step.

2. The mix of claim 1 wherein said mix has a composition that includes:
0 to about 30 wt % fat
0.1 to about 18 wt % protein
0 to about 45 wt % sweetener
0 to about 3 wt % stabilizer
0 to about 4 wt % emulsifier

3. The mix of claim 1 wherein said mix has a composition that includes:
0 to about 18 wt % fat
0.1 to about 6 wt % protein
0 to about 35 wt % sweetener
0 to about 1 wt % stabilizer
0 to about 2 wt % emulsifier

4. The mix of claim 1 which contains no dairy ingredients and can be classified as a dairy analogue frozen dessert mix.

5. The mix of claim 1 which contains a blend of plant and dairy ingredients.
